(19) United States
(12) Patent Application Publication
(10) Pub. No.: US 2025/0219339 A1
(43) Pub. Date: Jul. 3, 2025

(54) CONNECTION DEVICE

(71) Applicant: NSK Ltd., Shinagawa-ku, Tokyo (JP)

(72) Inventors: Takato YAMAGISHI, Fujisawa-shi, Kanagawa (JP); Satoshi KATTO, Fujisawa-shi, Kanagawa (JP)

(21) Appl. No.: 18/850,564

(22) PCT Filed: Mar. 29, 2023
(86) PCT No.: PCT/JP2023/012840

§ 371 Date: Sep. 25, 2024

(30) Foreign Application Priority Data
Mar. 29, 2022 (JP) 2022-053991

(51) Int. Cl. H01R 39/02; H02K 5/22

(52) U.S. Cl. CPC H01R 39/02; H02K 5/225; H02K 2205/09

(57) ABSTRACT

A connection device electrically connects a hollow rotary shaft and a conductive member. The connection device includes a first conductive portion attached to an end of the rotary shaft, and a second conductive portion inserted into a recess of the first conductive portion to electrically connect the first conductive portion and the conductive member. The first conductive portion includes a first abutting portion that abuts on the second conductive portion. The second conductive portion includes a second abutting portion that abuts on the first abutting portion. At least one of the first abutting portion and the second abutting portion has a protrusion shape. The first abutting portion and the second abutting portion abut on each other on a rotation axis of the rotary shaft.

### TECHNICAL FIELD

The present disclosure relates to a connection device that electrically connects a hollow rotary shaft rotatably supported by a bearing and a conductive member.

### BACKGROUND ART

There is a case where a rotary shaft driven by an electric motor is electrically charged. When electric charge charged on the rotary shaft flows as a current through a bearing that supports the rotary shaft, electrolytic corrosion sometimes occurs in the bearing. In order to prevent the current from flowing through the bearing, for example, Patent Literature 1 describes that a neutralizing member is brought into contact with an end of a rotary shaft, and electric charge charged on the rotary shaft is caused to flow through a ground wire via the neutralizing member.

### CITATION LIST

### Patent Literature

Patent Literature 1: Japanese Patent No. 6242566

### SUMMARY OF INVENTION

### Technical Problem

In general, a hollow rotary shaft may be used as the rotary shaft in order to use the inside of the shaft as an oil passage for lubricating oil. In this case, since the rotary shaft is hollow, it is difficult to bring the neutralizing member into contact with the end of the rotary shaft, for example, in the configuration described in Patent Literature 1 above.

Therefore, the present disclosure describes a connection device capable of electrically connecting a hollow rotary shaft and a conductive member while allowing the inside of the rotary shaft to function as an oil passage.

### Solution to Problem

A connection device according to one aspect of the present disclosure is [1] “A connection device that electrically connects a conductive member and a rotary shaft that is hollow and rotatably supported by a bearing, the connection device including: a first conductive portion having conductivity and including a recess, and attached to an end of the rotary shaft in such a manner that an opening of the recess faces outward; and a second conductive portion abutting on a bottom of the recess with one end being inserted into the recess and having the other end being attached to the conductive member, the second conductive portion electrically connecting the first conductive portion and the conductive member, in which the first conductive portion includes: a fitting portion that is provided on an outer peripheral surface of the first conductive portion and is fitted and fixed to an inner peripheral surface of the end of the rotary shaft; and a first abutting portion that is provided at the bottom of the recess in the first conductive portion and abuts on the second conductive portion, an oil passage hole penetrating the bottom of the recess is formed around the first abutting portion at the bottom of the recess in the first conductive portion, the second conductive portion includes a second abutting portion that is provided at the one end of the second conductive portion and abuts on the first abutting portion, at least one of the first abutting portion and the second abutting portion has a protrusion shape, and the first abutting portion and the second abutting portion abut on each other on a rotation axis of the rotary shaft”.

This connection device includes the first conductive portion fitted and fixed to the inner peripheral surface of the end of the rotary shaft. Therefore, in the connection device, even if the rotary shaft is hollow, the first abutting portion and the second abutting portion can abut on each other on the rotation axis of the rotary shaft to electrically connect the rotary shaft and the conductive member. Note that at least one of the first abutting portion and the second abutting portion has a protrusion shape. Therefore, the first abutting portion and the second abutting portion are in point contact with each other on the rotation axis of the rotary shaft. That is, a difference in peripheral speed between the first abutting portion and the second abutting portion is zero at a contact part between them. Therefore, the connection device can suppress intrusion of lubricating oil between the first abutting portion and the second abutting portion, and can maintain the electrical connection between the first conductive portion and the second conductive portion. In addition, the oil passage hole is provided at the bottom of the recess of the first conductive portion. Therefore, when the first conductive portion is attached to the end of the rotary shaft, an oil passage inside the rotary shaft is not occluded by the first conductive portion. As described above, the connection device can electrically connect the rotary shaft and the conductive member while causing the inside of the hollow rotary shaft to function as the oil passage.

The above connection device may be [2] “The connection device according to [1] above, in which the first conductive portion includes: a main body that has conductivity, includes the recess, and has an outer peripheral surface on which the fitting portion is provided; and a steel ball that has conductivity and is attached to the bottom of the recess of the main body to constitute the first abutting portion”. In this case, in the connection device, the first conductive portion and the second conductive portion can be easily brought into point contact by using the steel ball.

The above connection device may be [3] “The connection device according to [2] above, in which the recess of the main body has a bottom surface provided with an accommodating portion that has a recess shape and accommodates the steel ball inside, and the accommodating portion includes: a surrounding portion that has a tubular shape, extends along a direction of the rotation axis of the rotary shaft and surrounds the steel ball; and an inward extending portion that extends inward from an end of the surrounding portion on a side close to a bottom of the recess shape of the accommodating portion, the inward extending portion abutting on the steel ball”. In this connection device, the steel ball is prevented from falling off from the surrounding portion by the inward extending portion. In addition, the one end of the second conductive portion abuts on the steel ball at an end of the surrounding portion on a side where the inward extending portion is not provided. That is, the first conductive portion can hold the steel ball only by providing the inward extending portion in one of openings at both the ends of the surrounding portion. As described above, a configuration of the first conductive portion that holds the steel ball can be simplified in this connection device.

The above connection device may be [4] “The connection device according to [2] above, in which the recess of the main body has a bottom surface provided with a hole in which the steel ball is disposed, and the first conductive portion further includes a holding portion that has conductivity, is provided at a rim of the hole in the main body, and holds the steel ball by crimping”. In this case, the first conductive portion can easily hold the steel ball by crimping using the holding portion. Therefore, in this connection device, for example, the steel ball can be prevented from falling off from the first conductive portion at the time of assembling the connection device, and the assemblability can be improved.

The above connection device may be [5] “The connection device according to any one of [1] to [4] above, in which the first conductive portion further includes a filter that covers the oil passage hole”. In this case, the connection device can prevent foreign matter contained in the lubricating oil flowing inside the rotary shaft from flowing.

The above connection device may be [6] “The connection device according to any one of [1] to [5] above, in which an opening area of one end and an opening area of the other end of the oil passage hole are different from each other, and the one end and the other end of the oil passage hole are at different positions in a rotation direction of the rotary shaft. In this case, since the oil passage hole is inclined with respect to the rotation axis of the rotary shaft and has the different opening areas in the connection device, a pressure difference occurs in the lubricating oil in the oil passage hole between both the ends of the oil passage hole when the first conductive portion rotates together with the rotary shaft. That is, the connection device can pressure-feed the lubricating oil from the end on a side where the opening area is smaller toward the end on a side where the opening area is larger. As described above, the connection device can pressure-feed the lubricating oil when the rotary shaft rotates.

A connection device according to another aspect of the present disclosure is [7] “A connection device that electrically connects a conductive member and a rotary shaft that is hollow and rotatably supported by a bearing, the connection device including: a first conductive portion having conductivity, including a recess, and attached to an end of the rotary shaft in such a manner that an opening of the recess faces outward; and a second conductive portion abutting on a bottom of the recess with one end being inserted into the recess and having another end being attached to the conductive member, the second conductive portion electrically connecting the first conductive portion and the conductive member, in which the first conductive portion includes: a main body that has conductivity, includes the recess, and has an outer peripheral surface on which a fitting portion is formed, the fitting portion being fitted and fixed to an inner peripheral surface of the end of the rotary shaft; a steel ball that has conductivity and is disposed in a hole provided in a bottom surface of the recess of the main body; and a plurality of holding portions that have conductivity, are provided at a rim of the hole of the main body, and hold the steel ball by crimping, the second conductive portion includes a second abutting portion that is provided at the one end of the second conductive portion and abuts on the steel ball, the steel ball and the second abutting portion abut on each other on a rotation axis of the rotary shaft, the plurality of holding portions are provided at predetermined intervals along a circumferential direction at the rim of the hole of the main body, and an oil passage hole formed by a gap between the rim of the hole and the steel ball is provided in a portion where the holding portions are not provided in the rim of the hole of the main body”.

This connection device includes the first conductive portion fitted and fixed to the inner peripheral surface of the end of the rotary shaft. Therefore, in the connection device, even if the rotary shaft is hollow, the first abutting portion and the second abutting portion can abut on each other on the rotation axis of the rotary shaft to electrically connect the rotary shaft and the conductive member. Note that the steel ball of the first conductive portion and the second abutting portion of the second conductive portion are brought into point contact with each other on the rotation axis of the rotary shaft. That is, a difference in peripheral speed between the steel ball and the second abutting portion is zero at a contact part between them. Therefore, the connection device can suppress intrusion of lubricating oil between the steel ball and the second abutting portion, and can maintain the electrical connection between the steel ball and the second conductive portion. In addition, a plurality of holding portions holding the steel ball by crimping are provided at predetermined intervals along a circumferential direction of a hole of a main body. As a result, the oil passage hole can be formed in a portion where the holding portions are not provided in the first conductive portion. Therefore, when the first conductive portion is attached to the end of the rotary shaft, an oil passage inside the rotary shaft is not occluded by the first conductive portion. As described above, the connection device can electrically connect the rotary shaft and the conductive member while causing the inside of the hollow rotary shaft to function as the oil passage.

### Advantageous Effects of Invention

According to various aspects of the present disclosure, it is possible to electrically connect the hollow rotary shaft and the conductive member while allowing the inside of the rotary shaft to function as the oil passage.

### BRIEF DESCRIPTION OF DRAWINGS

FIG. 1 is a cross-sectional view around a rotary shaft to which a connection device is attached.

FIG. 2 is an exploded perspective view of the connection device of FIG. 1.

FIG. 3 is a cross-sectional view illustrating an internal structure of a connection device according to a first modification.

FIG. 4 is an exploded perspective view of the connection device of FIG. 3.

FIG. 5 is a cross-sectional view illustrating an internal structure of a connection device according to a second modification.

FIG. 6 is an exploded perspective view of the connection device of FIG. 5.

FIG. 7 is a cross-sectional view illustrating an internal structure of a connection device according to a third modification.

FIG. 8 is an exploded perspective view of the connection device of FIG. 7.

FIG. 9 is a partial cross-sectional view illustrating a partially cut ball holder of the connection device of FIG. 7.

FIG. 10 is a partial cross-sectional view illustrating a partially cut ball holder of the connection device of FIG. 7.

FIG. 11 is a view illustrating an example of a crimping method in a case where a steel ball is fixed by crimping.

FIG. 12 is a cross-sectional view illustrating an example of a first conductive portion that holds the steel ball by crimping.

FIG. 13 is a front view illustrating another example of the first conductive portion that holds the steel ball by crimping.

FIG. 14 is a cross-sectional view of the first conductive portion illustrating another example of a method of holding the steel ball.

### DESCRIPTION OF EMBODIMENTS

Hereinafter, embodiments of the present disclosure will be described with reference to the drawings. Note that the same or corresponding elements in the drawings are denoted by the same reference signs, and redundant description thereof will be omitted.

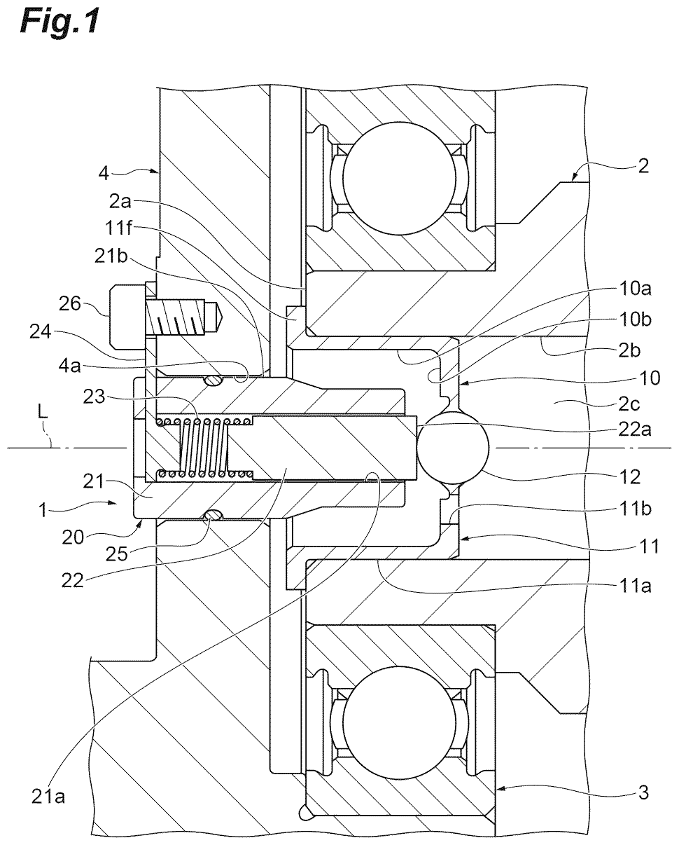

As illustrated in FIG. 1, a connection device 1 electrically connects a rotary shaft 2 rotatably supported by a bearing 3 and a housing (conductive member) 4. The rotary shaft 2 may be a shaft of an electric motor or a shaft connected to a shaft of the electric motor via a gear. In the present embodiment, the rotary shaft 2 is a hollow rotary shaft (hollow structure) in which a shaft oil passage 2c extending along a rotation axis L as a rotation center of the rotary shaft 2 is formed. Lubricating oil flows through the shaft oil passage 2c of the rotary shaft 2. The bearing 3 supports the rotary shaft 2 so as to be rotatable about the rotation axis L. A type of the bearing 3 is not particularly limited as long as the rotary shaft 2 can be rotatably supported.

The housing 4 accommodates the rotary shaft 2, the bearing 3, and the like. The housing 4 has conductivity. In the present embodiment, the connection device 1 electrically connects the rotary shaft 2 and the housing 4 to form a conductive path having a lower resistance value than a conductive path from the rotary shaft 2 to the housing 4 via the bearing 3.

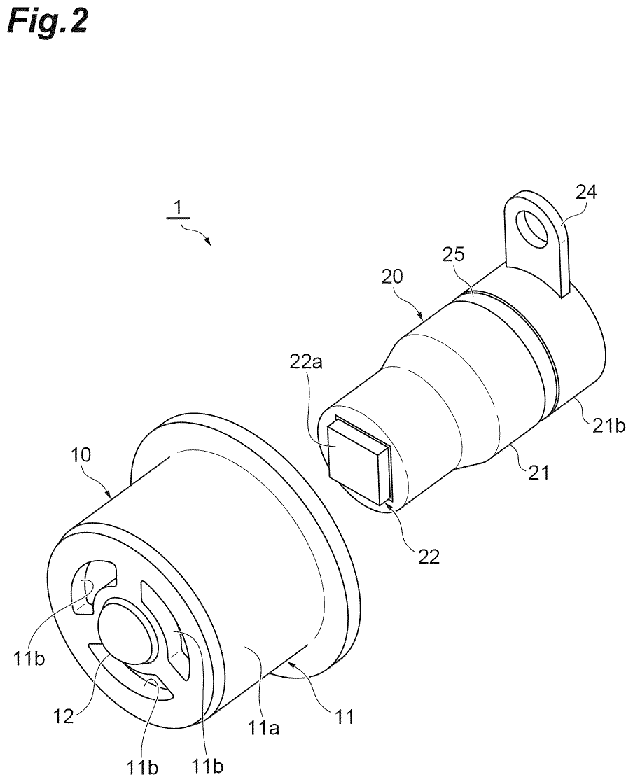

As illustrated in FIGS. 1 and 2, the connection device 1 includes a first conductive portion 10 and a second conductive portion 20. The first conductive portion 10 has conductivity. In addition, the first conductive portion 10 has a shape including the recess 10a. The first conductive portion 10 is attached to an end 2a of the rotary shaft 2 such that an opening of the recess 10a faces outward.

More specifically, the first conductive portion 10 includes a ball holder (main body) 11 and a steel ball (first abutting portion) 12. The ball holder 11 and the steel ball 12 each have conductivity. The ball holder 11 has a shape including the recess 10a. As an example, the ball holder 11 is formed by pressing a steel plate.

The steel ball 12 may be, for example, a ball used for a bearing. The steel ball 12 is attached to the bottom 10b of the recess 10a of the ball holder 11. Here, as an example, the steel ball 12 is fitted into a hole provided in the bottom 10b of the recess 10a of the ball holder 11 and is fixed by crimping. As described above, the steel ball 12 is provided at the bottom 10b of the recess 10a in the first conductive portion 10, and constitutes a protrusion-shaped abutting portion that abuts on the second conductive portion 20 (an end surface 22a of a brush 22). The steel ball 12 is attached to the ball holder 11 such that a center of the steel ball 12 is located on the rotation axis L that is the rotation center of the rotary shaft 2.

An outer peripheral surface of the ball holder 11 is provided with a fitting portion 11a that is fitted and fixed to an inner peripheral surface 2b of the end 2a of the rotary shaft 2. That is, the ball holder 11 is fitted and fixed to the inner peripheral surface 2b forming the shaft oil passage 2c in the rotary shaft 2. The ball holder 11 is fitted and fixed to the inner peripheral surface 2b of the end 2a of the rotary shaft 2 such that the opening of the recess 10a faces outward. The fitting portion 11a of the ball holder 11 and the inner peripheral surface 2b of the rotary shaft 2 are engaged with each other. Therefore, the ball holder 11 rotates integrally with the rotary shaft 2. The steel ball 12 abuts on one end (the end surface 22a of the brush 22) of the second conductive portion 20 in the recess 10a of the ball holder 11.

In addition, at the bottom 10b of the recess 10a in the ball holder 11, an oil passage hole 11b penetrating the bottom 10b of the recess 10a is provided around the steel ball 12. The lubricating oil flowing through the shaft oil passage 2c of the rotary shaft 2 can flow through the oil passage hole 11b. Note that a shape and the number of the oil passage holes 11b are not particularly limited.

One end of the second conductive portion 20 is inserted into the recess 10a of the first conductive portion 10 to abut on the steel ball 12 provided at the bottom 10b of the recess 10a. In addition, the other end of the second conductive portion 20 is attached to the housing 4 to electrically connect the first conductive portion 10 and the housing 4. More specifically, the second conductive portion 20 includes a brush holder 21, the brush 22, a spring 23, and a conductive terminal 24.

One end of the brush holder 21 is inserted into the recess 10a of the first conductive portion 10. The other end of the brush holder 21 is held by the housing 4. In the present embodiment, the housing 4 has a hole 4a on the rotation axis L that is the rotation center of the rotary shaft 2. The brush holder 21 is held in the housing 4 with the other end being inserted into the hole 4a. Note that an O-ring 25 is attached to an outer peripheral surface 21b of the brush holder 21. The O-ring 25 occludes a space between an inner peripheral surface of the hole 4a of the housing 4 and the outer peripheral surface 21b of the brush holder 21. As an example, the brush holder 21 is made of resin. The brush holder 21 has a holder hole 21a extending along the rotation axis L.

The brush 22 is inserted into the holder hole 21a of the brush holder 21. The brush 22 can slide along the rotation axis L in the holder hole 21a in a state where the spring 23 is not provided. The brush 22 has conductivity. As the brush 22, for example, a carbon brush can be used. In the brush 22, an end on the bottom 10b side (the steel ball 12 side) of the recess 10a of the first conductive portion 10 protrudes from the holder hole 21a of the brush holder 21 by a predetermined length.

In the brush 22, an end surface (second abutting portion) 22a on the bottom 10b side (the steel ball 12 side) of the recess 10a of the first conductive portion 10 abuts on the steel ball 12. That is, the end surface 22a of the brush 22 is provided at the one end (end on the steel ball 12 side) of the second conductive portion 20, and constitutes the abutting portion that abuts on the steel ball 12 of the first conductive portion 10. A shape of the end surface 22a may be flat, a recess shape (as an example, a shape recessed in an arc shape), or a protrusion shape (as an example, a shape protruding in an arc shape). In the present embodiment, the end surface 22a may be in point contact with the steel ball 12.

Note that the steel ball 12 is provided such that the center of the steel ball 12 is located on the rotation axis L as described above. Therefore, the end surface 22a of the brush 22 and the steel ball 12 are in point contact with each other on the rotation axis L. As a result, even when the first conductive portion 10 rotates together with the rotary shaft 2, a position of a contact point between the end surface 22a of the brush 22 and the steel ball 12 is not deviated. That is, a difference in peripheral speed between the end surface 22a and the steel ball 12 is zero at a connection part between them.

The conductive terminal 24 is attached to the other end of the brush holder 21 (an end opposite to the side to be inserted into the recess 10a). The conductive terminal 24 is provided outside the housing 4. The conductive terminal 24 has conductivity. One end of the conductive terminal 24 is embedded and fixed in the other end of the brush holder 21. The one end of the conductive terminal 24 faces the brush 22 in a direction of the rotation axis L. The other end of the conductive terminal 24 protrudes outward from the brush holder 21. The other end of the conductive terminal 24 is fixed to an outer surface of the housing 4 by the bolt 26.

The spring 23 is disposed between the brush 22 and the conductive terminal 24 in the holder hole 21a of the brush holder 21. The spring 23 has conductivity. The spring 23 is a compression spring. The spring 23 biases the brush 22 in a direction in which the brush 22 approaches the steel ball 12. As a result, the brush 22 is brought into point contact with the steel ball 12 in a state where the connection device 1 is attached. That is, the brush 22 and the steel ball 12 are electrically connected.

Next, the conductive path between the rotary shaft 2 and the housing 4 in a case where the connection device 1 is used will be described. In the present embodiment, the ball holder 11, the steel ball 12, the brush 22, the spring 23, and the conductive terminal 24 have conductivity. Therefore, the rotary shaft 2 is electrically connected to the housing 4 via the ball holder 11, the steel ball 12, the brush 22, the spring 23, and the conductive terminal 24. That is, the ball holder 11, the steel ball 12, the brush 22, the spring 23, and the conductive terminal 24 form the conductive path electrically connecting the rotary shaft 2 and the housing 4. As a result, the rotary shaft 2 and the housing 4 are electrically connected to each other even in a rotating state of the rotary shaft 2.

As described above, the connection device 1 includes the first conductive portion 10 fitted and fixed to the inner peripheral surface 2b of the end 2a of the rotary shaft 2. Therefore, in the connection device 1, even if the rotary shaft 2 is hollow, the steel ball 12 of the first conductive portion 10 and the brush 22 of the second conductive portion 20 can be made to abut on each other on the rotation axis L of the rotary shaft 2 to electrically connect the rotary shaft 2 and the housing 4.

Note that a surface of the steel ball 12 on the brush 22 side has a protrusion shape since the steel ball 12 is spherical. Therefore, the steel ball 12 and the brush 22 are in point contact with each other on the rotation axis L of the rotary shaft 2. That is, the difference in peripheral speed between the steel ball 12 and the end surface 22a of the brush 22 is zero at a contact part between them. Therefore, the connection device 1 can suppress intrusion of lubricating oil between the steel ball 12 and the end surface 22a of the brush 22, and can maintain the electrical connection between the first conductive portion 10 and the second conductive portion 20.

In addition, the oil passage hole 11b is provided at the bottom 10b of the recess 10a of the first conductive portion 10. Therefore, when the first conductive portion 10 is attached to the end 2a of the rotary shaft 2, the shaft oil passage 2c inside the rotary shaft 2 is not occluded by the first conductive portion 10. As described above, the connection device 1 can electrically connect the rotary shaft 2 and the housing 4 while causing the shaft oil passage 2c inside the hollow rotary shaft 2 to function as an oil passage.

The first conductive portion 10 includes the steel ball 12 that abuts on the brush 22 of the second conductive portion 20. As a result, in the connection device 1, the first conductive portion 10 and the second conductive portion 20 can be easily brought into point contact with each other by using the steel ball 12.

### First Modification

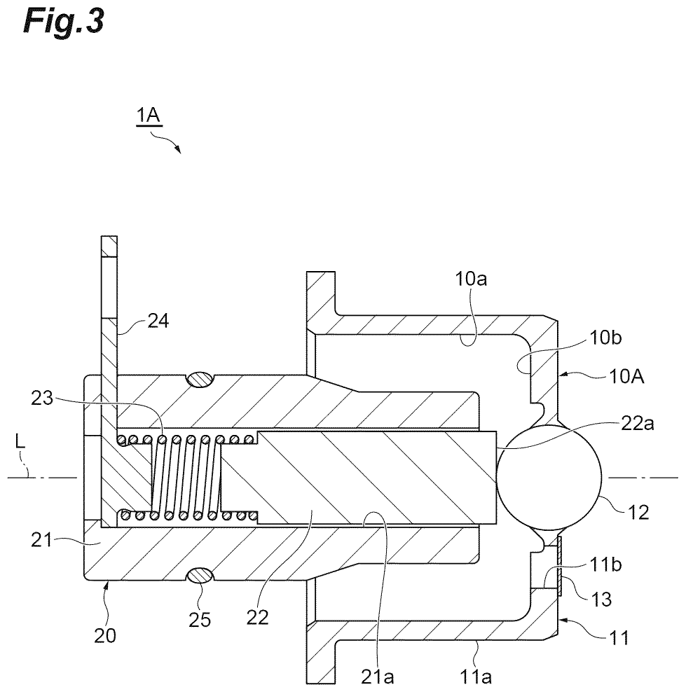

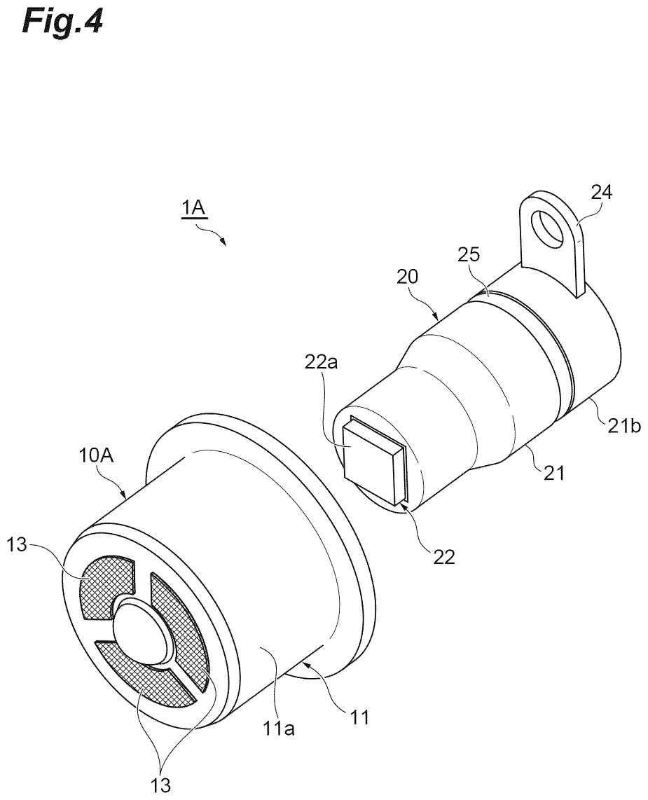

Next, a first modification of the connection device will be described. Hereinafter, differences from the connection device 1 according to the embodiment will be mainly described, and the same components will be denoted by the same reference signs and detailed description thereof will be omitted. As illustrated in FIGS. 3 and 4, a connection device 1A according to the first modification includes a first conductive portion 10A instead of the first conductive portion 10 in the embodiment.

The first conductive portion 10A includes the ball holder 11, the steel ball 12, and a filter 13. The filter 13 covers the oil passage hole 11b provided in the ball holder 11. Note that the filter 13 may be provided in the oil passage hole 11b or may be provided to cover the oil passage hole 11b on an end surface of the ball holder 11. The filter 13 includes a fine hole or flow path through which lubricating oil flowing through the shaft oil passage 2c of the rotary shaft 2 can flow. In addition, the filter 13 has a function of capturing foreign matter other than the lubricating oil to be allowed to flow. A type of the filter 13 is not particularly limited.

The connection device 1A according to the present modification can suppress intrusion of the lubricating oil between the steel ball 12 and the end surface 22a of the brush 22, and can maintain electrical connection between the first conductive portion 10A and the second conductive portion 20, which is similar to the connection device 1 according to the embodiment. Further, since the connection device 1A includes the filter 13, it is possible to capture the foreign matter contained in the lubricating oil flowing through the shaft oil passage 2c of the rotary shaft 2 and to prevent the foreign matter from flowing. The filter 13 can be provided in an oil passage hole also in other modifications.

### Second Modification

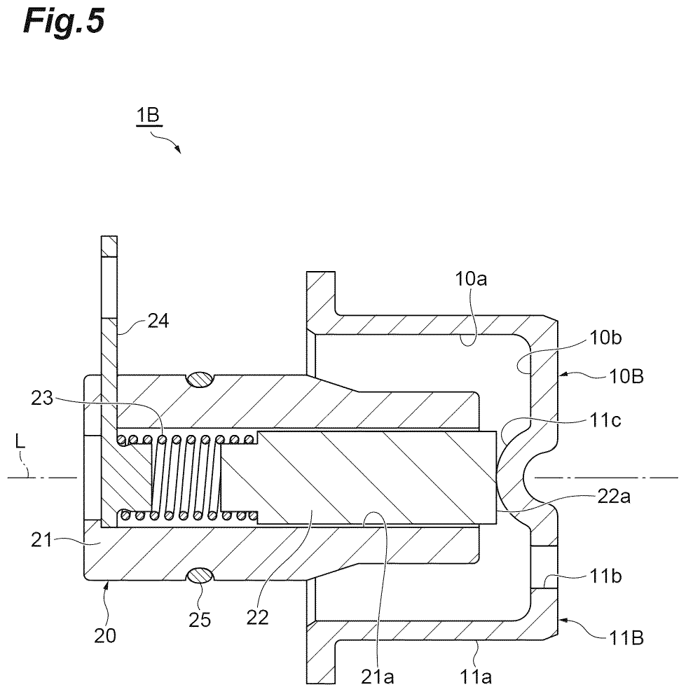

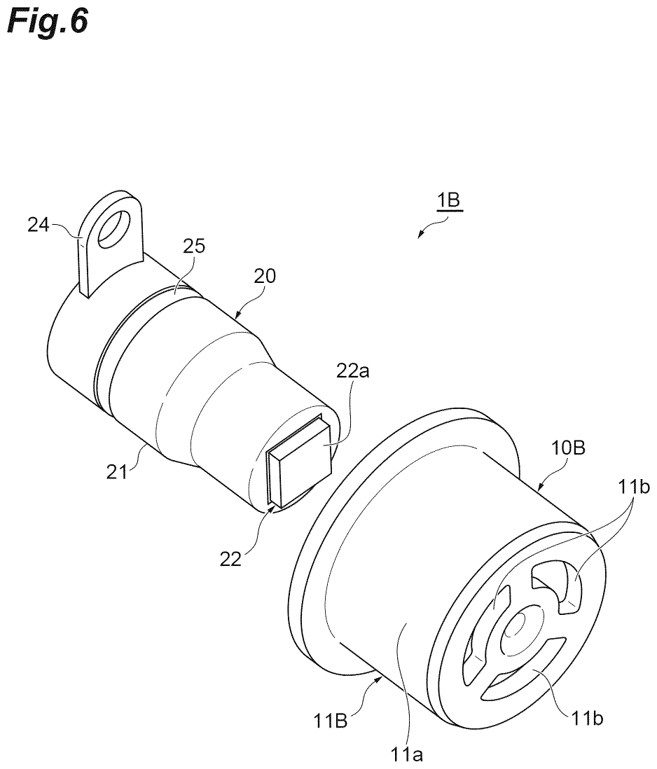

Next, a second modification of the connection device will be described. As illustrated in FIGS. 5 and 6, a connection device 1B according to the second modification includes a first conductive portion 10B instead of the first conductive portion 10 in the embodiment.

The first conductive portion 10B includes a main body 11B. The main body 11B has a shape including the recess 10a, which is similar to the ball holder 11 in the embodiment. A protrusion (first abutting portion) 11c abutting on the brush 22 (the end surface 22a) of the second conductive portion 20 is provided on the bottom 10b of the recess 10a in the main body 11B.

The protrusion 11c has a protrusion shape protruding toward the end surface 22a of the brush 22. The protrusion 11c is provided on the main body 11B such that a vertex of the protrusion 11c is located on the rotation axis L that is the rotation center of the rotary shaft 2. That is, the protrusion 11c and the end surface 22a of the brush 22 are in point contact with each other in a shape of the rotation axis L.

In addition, the oil passage hole 11b is provided around the protrusion 11c at the bottom 10b of the recess 10a in the main body 11B. As an example, the main body 11B is integrally formed with the oil passage hole 11b and the protrusion 11c by pressing a steel plate.

As described above, the connection device 1B including the protrusion 11c according to the present modification can suppress intrusion of lubricating oil between the protrusion 11c and the end surface 22a of the brush 22, and can maintain electrical connection between the first conductive portion 10B and the second conductive portion 20, which is similar to the connection device 1 according to the embodiment.

### Third Modification

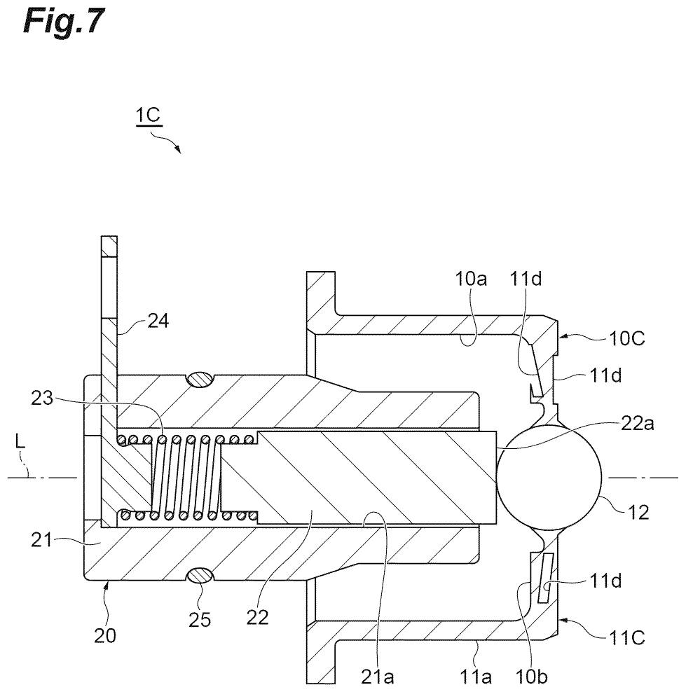

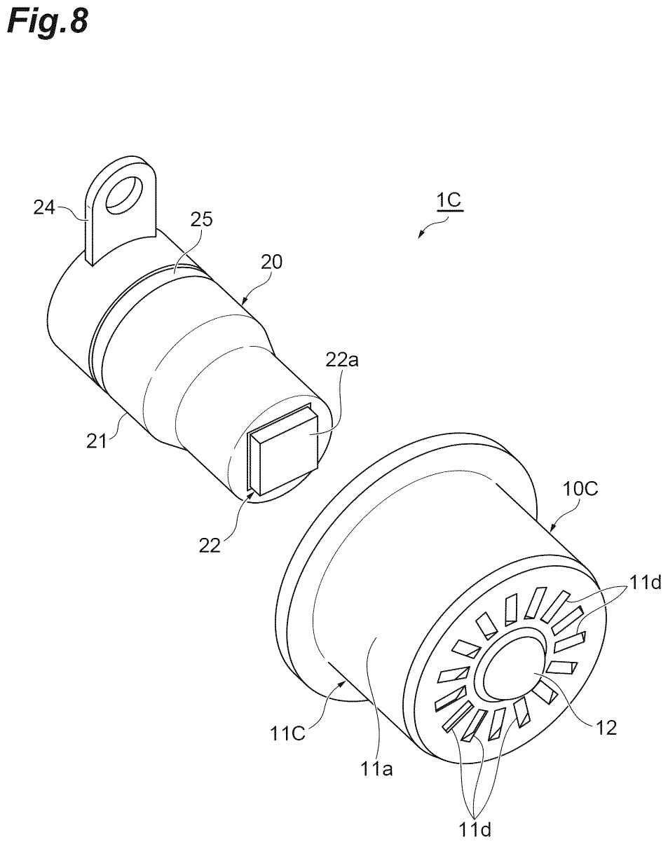

Next, a third modification of the connection device will be described. As illustrated in FIGS. 7 to 10, a connection device 1C according to the third modification includes a first conductive portion 10C instead of the first conductive portion 10 in the embodiment.

The first conductive portion 10C includes a ball holder (main body) 11C and the steel ball 12. The ball holder 11C has a shape including the recess 10a, which is similar to the ball holder 11 in the embodiment. The steel ball 12 is attached to the ball holder 11C such that a center of the steel ball 12 is located on the rotation axis L that is the rotation center of the rotary shaft 2.

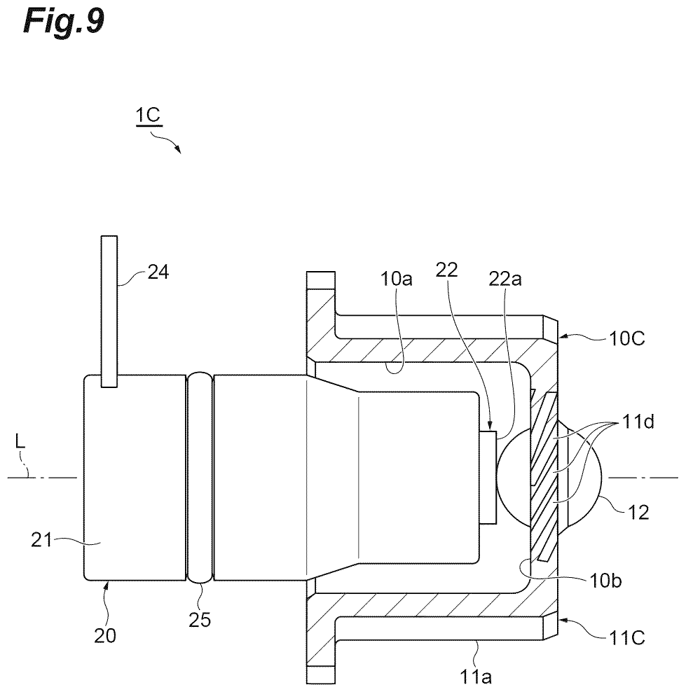

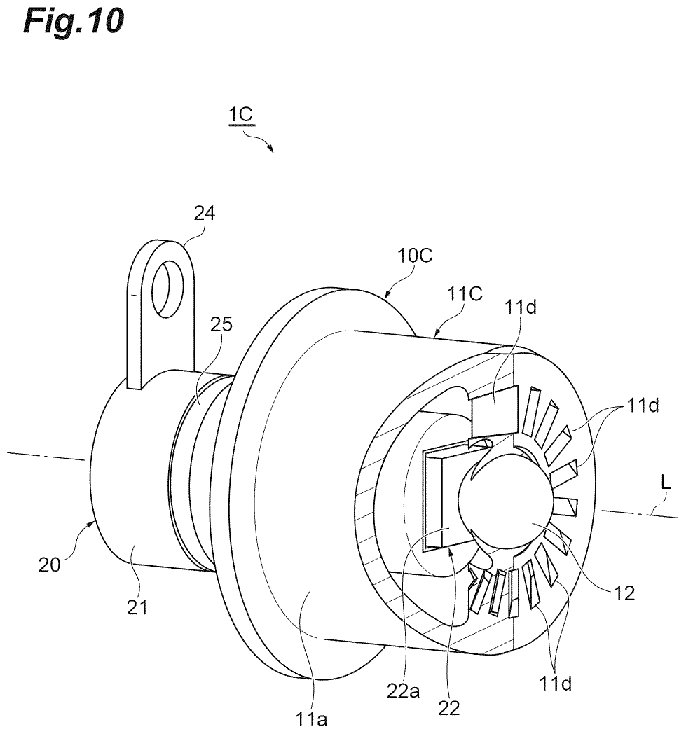

In addition, a plurality of oil passage holes 11d penetrating the bottom 10b of the recess 10a are formed around the steel ball 12 at the bottom 10b of the recess 10a in the ball holder 11C. As illustrated in FIGS. 9 and 10, the oil passage holes 11d are provided at the bottom 10b of the ball holder 11C so as to be inclined with respect to the rotation axis L. Note that FIG. 9 illustrates a cross section of the ball holder 11C taken along the rotation axis L at a position deviated from the rotation axis L. In addition, FIG. 10 illustrates a cross section of the ball holder 11C taken along an extending direction of the oil passage hole 11d located at the upper part in the drawing among the plurality of oil passage holes 11d.

Here, the inclination of the oil passage hole 11d with respect to the rotation axis L will be described in more detail. One end and the other end of the oil passage hole 11d are at different positions in a rotation direction of the rotary shaft 2. Note that the positions of the ends here can be central positions of openings of the ends of the oil passage hole 11d. In addition, one end and the other end of the oil passage hole 11d are at different positions in a direction orthogonal to the rotation axis L. That is, any one end of both the ends of the oil passage hole 11d is located near the rotation axis L, and the other end is located farther away from the rotation axis L than the one end. Note that the positions of the ends here can be central positions of openings of the ends of the oil passage hole 11d. As described above, the plurality of oil passage holes 11d are inclined in a spiral shape (swirl shape) with respect to the rotation axis L around the rotation axis L.

In addition, an opening area of one end of the oil passage hole of the oil passage hole 11d is different from an opening area of the other end. In the present modification, an opening area of an end on an inner surface side of the ball holder 11C out of both the ends of the oil passage hole 11d is smaller than an opening area of an end on an outer surface side of the ball holder 11C (see FIG. 10).

Here, in the present modification, the oil passage hole 11d is inclined with respect to the rotation axis L, and the opening areas of both the ends of the oil passage hole 11d are different from each other. As a result, when the ball holder 11C rotates together with the rotary shaft 2, a pressure difference occurs in lubricating oil in the oil passage hole 11d between both the ends of the oil passage hole 11d. That is, by using the first conductive portion 10C having the oil passage hole 11d, the connection device 1C can pressure-feed the lubricating oil from the end on the side where the opening area of the oil passage hole 11d is smaller toward the end on the side where the opening area is larger.

Note that a direction of the inclination of the oil passage hole 11d with respect to the rotation axis L and the opening areas of both the ends are appropriately set according to the rotation direction of the rotary shaft 2 and a pressure feeding direction of the lubricating oil.

As described above, the connection device 1C according to the present modification can suppress intrusion of the lubricating oil between the steel ball 12 and the end surface 22a of the brush 22, and can maintain electrical connection between the first conductive portion 10C and the second conductive portion 20, which is similar to the connection device 1 according to the embodiment. Further, since the connection device 1C includes the ball holder 11C having the oil passage holes 11d inclined with respect to the rotation axis L and having the different opening areas at both the ends, it is possible to pressure-feed the lubricating oil when the rotary shaft 2 rotates.

Although the embodiment and various modifications of the present disclosure have been described above, the present disclosure is not limited to the above-described embodiment and various modifications. For example, although the steel ball 12 is provided in each of the first conductive portions 10,10A, and 10C, a steel ball may be attached to a distal end of the brush 22, and the steel ball may abut on the bottom 10b of the recess 10a of each of the first conductive portions 10 and 10A to 10C.

Although the connection device 1 and the like electrically connect the rotary shaft 2 and the housing 4, a conductive member other than the housing 4 may be electrically connected to the rotary shaft 2. In addition, the brush holder 21 may have conductivity. In this case, the brush holder 21 may function as a part of a conductive path between the rotary shaft 2 and the housing 4.

In addition, in the connection device 1 according to the embodiment, a seal that surrounds an abutment part between the brush 22 and the steel ball 12 may be provided between an end surface of the brush holder 21 on the steel ball 12 side and the bottom 10b of the recess 10a in the ball holder 11. In this case, it is possible to further suppress intrusion of lubricating oil between the brush 22 and the steel ball 12. This seal may also be applied to the connection devices 1A to 1C according to the respective modifications.

In the connection device 1 according to the embodiment, the ball holder 11 is fixed to the rotary shaft 2 as the fitting portion 11a of the ball holder 11 is fit into the inner peripheral surface 2b of the rotary shaft 2. It is not limited to this fixing method. For example, a flange 11f (see FIG. 1) projecting outward from an open edge of the recess 10a of the ball holder 11 may be fixed to the end 2a of the rotary shaft 2 with a bolt or the like. In this case, an outer peripheral surface (a part of the fitting portion 11a) of the ball holder 11 does not necessarily abut on the inner peripheral surface 2b of the rotary shaft 2. The ball holders 11 and 11C and the main body 11B according to the modifications may also adopt a method similar to this fixing method.

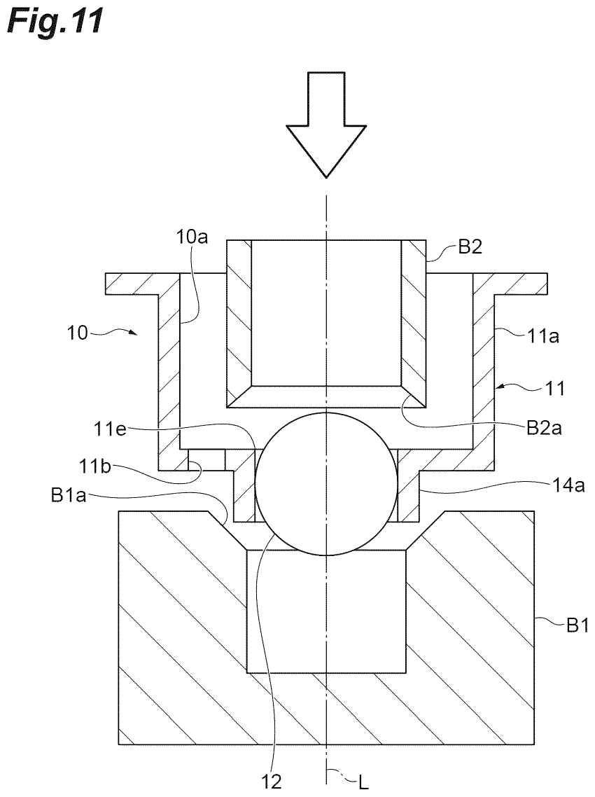

In addition, the steel ball 12 is fixed to the ball holder 11 by crimping in the above-described embodiment. An example of a specific method of fixing the steel ball 12 by crimping will be described. Note that the crimping method described here is an example, and other methods may be adopted. As illustrated in FIG. 11, the first conductive portion 10 includes the ball holder 11, the steel ball 12, and a deformable portion 14a having conductivity in a state before the steel ball 12 is fixed by crimping. The ball holder 11 is provided with the oil passage hole 11b.

A hole 11e in which the steel ball 12 is disposed is provided in a bottom surface of the recess 10a of the ball holder 11. The hole 11e has a size into which the steel ball 12 can be fitted. The deformable portion 14a is provided at a rim of the hole 11e of the ball holder 11. In this example, the deformable portion 14a has a tubular shape (for example, a cylindrical shape) extending along the direction of the rotation axis L of the rotary shaft 2 to which the ball holder 11 is attached. In addition, the deformable portion 14a extends from the rim of the hole 11e toward the outside of the ball holder 11. The steel ball 12 can be disposed inside the tubular deformable portion 14a.

In this example, the deformable portion 14a and a portion around the hole 11e in the ball holder 11 are deformed using a base B1 and a press die B2, and the steel ball 12 is fixed to the ball holder 11 by crimping. Here, the base B1 has an inclined surface B1a on which a distal end of the deformable portion 14a is made to abut. The inclined surface B1a is inclined in a direction in which a diameter of the distal end of the deformable portion 14a is reduced. The press die B2 is disposed inside the recess 10a of the ball holder 11. The press die B2 has a tubular shape surrounding the periphery of the hole 11e of the ball holder 11. An inclined surface B2a is formed at a distal end of the press die B2. The inclined surface B2a is inclined in a direction in which a portion of the ball holder 11 around the hole 11e (a member on the bottom surface of the ball holder 11) is gathered toward the hole 11e.

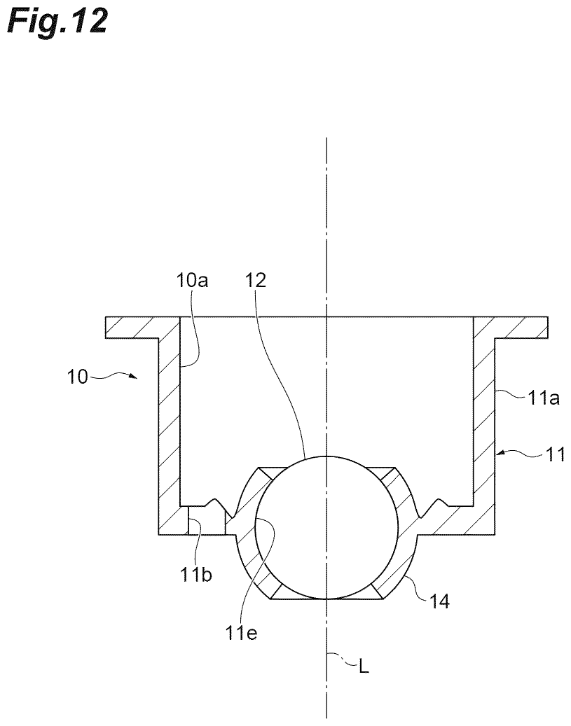

When the press die B2 is pressed against the base B1 side in this state, the deformable portion 14a is deformed by the inclined surface B1a, and the portion around the hole 11e is deformed inside the ball holder 11 by the inclined surface B2a. As a result, a holding portion 14 that holds the steel ball 12 is formed as illustrated in FIG. 12. Note that a case where the holding portion 14 extends to both the inside and the outside of the ball holder 11 is illustrated here as an example.

Note that the inclined surface B1a may be a curved surface such that the deformable portion 14a can be deformed along a shape of the steel ball 12. Similarly, the inclined surface B2a may be a curved surface. As shapes of the inclined surface B1a and the inclined surface B2a, an appropriate shape can be adopted such that the steel ball 12 can be fixed by crimping.

As described above, the first conductive portion 10 includes the holding portion 14 that is provided at the rim of the hole 11e of the ball holder 11 and holds the steel ball 12 by crimping. In this case, the first conductive portion 10 can easily hold the steel ball 12 by crimping using the holding portion 14. Therefore, in the connection device 1 including the first conductive portion 10, for example, the steel ball 12 can be prevented from falling off from the first conductive portion 10 at the time of assembling the connection device 1, and the assemblability can be improved. This crimping method may also be adopted for the ball holder according to each of the above-described modifications.

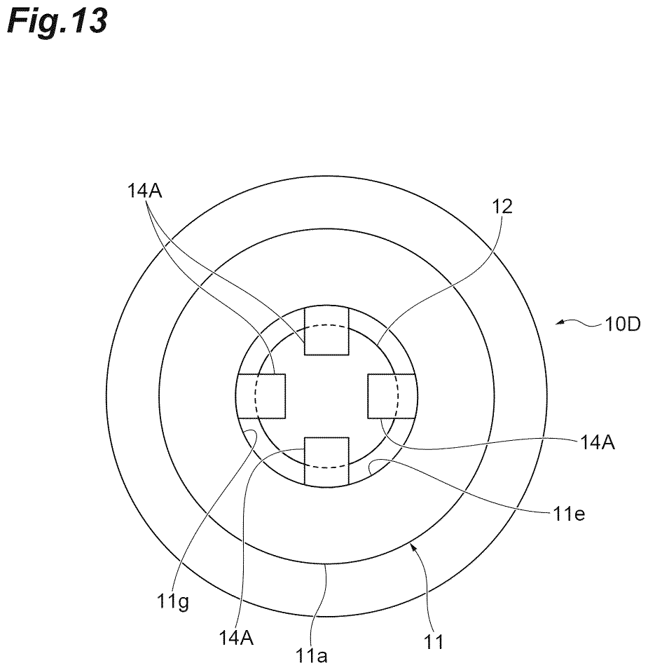

Note that the holding portion 14 is provided over the entire circumference of the steel ball 12 in the example described with reference to FIGS. 11 and 12. Hereinafter, a transformation example of the holding portion 14 will be described. As illustrated in FIG. 13, a first conductive portion 10D includes the ball holder 11, the steel ball 12, and a plurality of holding portions 14A. The ball holder 11, the steel ball 12, and the holding portions 14A have conductivity.

The plurality of holding portions 14A are provided on the rim of the hole 11e provided in the ball holder 11, and hold the steel ball 12 by crimping. The plurality of holding portions 14A are provided at predetermined intervals along the circumferential direction on the rim of the hole 11e of the ball holder 11. Note that four holding portions 14 are provided in the example illustrated in FIG. 13. However, the number of the holding portions 14 is not limited to four. In addition, the four holding portions 14A are provided at equal intervals along the circumferential direction on the rim of the hole 11e in the example illustrated in FIG. 13, but the holding portions 14A are not limited to being provided at equal intervals as long as the steel ball 12 can be held.

An oil passage hole 11g formed by a gap between the rim of the hole 11e and the steel ball 12 is provided at a portion where the holding portions 14A are not provided on the rim of the hole 11e of the ball holder 11. The oil passage hole 11g penetrates the recess-shaped bottom 10b of the ball holder 11. The lubricating oil flowing through the shaft oil passage 2c of the rotary shaft 2 can flow through the oil passage hole 11g. That is, it is not necessary to provide a hole as an oil passage hole in the ball holder 11 such as the oil passage hole 11b described with reference to FIG. 1. In the first conductive portion 10D, the oil passage hole 11g is formed by providing the holding portions 14A for performing crimping at predetermined intervals.

In the first conductive portion 10D, the oil passage hole 11g can be formed in the portion where the holding portions 14A are not provided as described above. Therefore, when the first conductive portion 10D is attached to the end 2a of the rotary shaft 2, the shaft oil passage 2c inside the rotary shaft 2 is not occluded by the first conductive portion 10D. As described above, a connection device including the first conductive portion 10D can electrically connect the rotary shaft 2 and the housing 4 while causing the shaft oil passage 2c inside the hollow rotary shaft 2 to function as an oil passage.

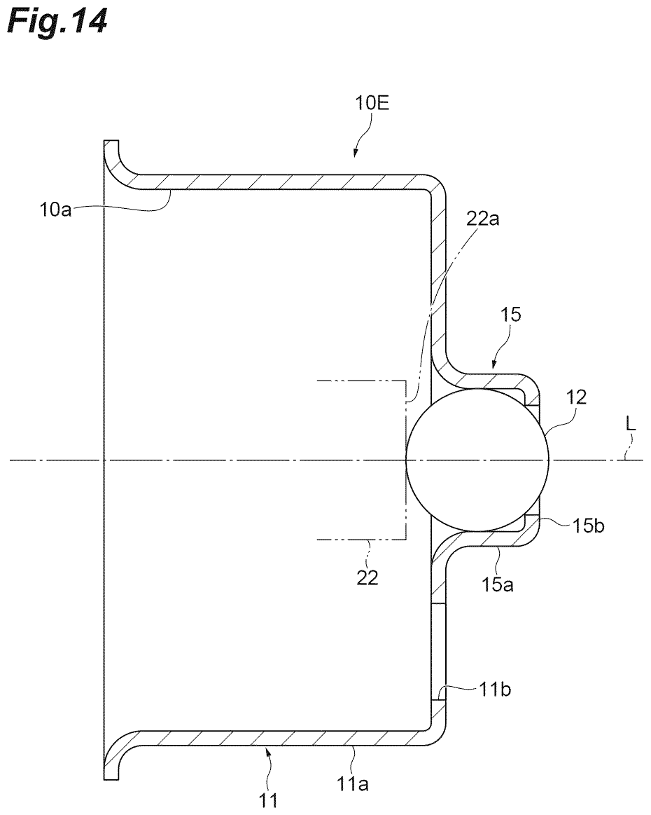

In addition, the steel ball 12 is attached to the first conductive portion 10 or the like by crimping in the above-described embodiment and respective modifications, but the steel ball 12 may be fixed to the first conductive portion 10 or the like by a method other than crimping. Specifically, for example, a first conductive portion 10E illustrated in FIG. 14 includes the ball holder 11, the steel ball 12, and an accommodating portion 15. The ball holder 11, the steel ball 12, and the accommodating portion 15 each have conductivity. The ball holder 11 is provided with the oil passage hole 11b.

The accommodating portion 15 has a recess shape and is provided on the bottom surface of the recess 10a of the ball holder 11. The accommodating portion 15 can accommodate the steel ball 12 inside. That is, the accommodating portion 15 protrudes outward from the bottom of the ball holder 11.

The accommodating portion 15 has a surrounding portion 15a and an inward extending portion 15b. The surrounding portion 15a extends along the direction of the rotation axis L of the rotary shaft 2 and has a tubular shape (for example, a cylindrical shape) surrounding the steel ball 12. The inward extending portion 15b extends inward from an end of the surrounding portion 15a on a side close to a bottom of the recess-shaped accommodating portion 15. That is, the inward extending portion 15b constitutes the bottom of the recess-shaped accommodating portion 15. The inward extending portion 15b abuts on the steel ball 12 accommodated in the surrounding portion 15a.

In a connection device including the first conductive portion 10E, the steel ball 12 is prevented from falling off from the surrounding portion 15a by the inward extending portion 15b. In addition, the brush 22 of the second conductive portion 20 (one end of the second conductive portion) abuts on the steel ball 12 at the end of the surrounding portion 15a on a side where the inward extending portion 15b is not provided. That is, the first conductive portion 10E can hold the steel ball 12 only by providing the inward extending portion 15b in one of openings at both ends of the surrounding portion 15a. As described above, a configuration of the first conductive portion 10E holding the steel ball 12 can be simplified in the connection device including the first conductive portion 10E.

### REFERENCE SIGNS LIST

1, 1A to 1C CONNECTION DEVICE
2 ROTARY SHAFT
3 BEARING
4 HOUSING (CONDUCTIVE MEMBER)
10, 10A to 10E FIRST CONDUCTIVE PORTION
10a RECESS
10b BOTTOM
11, 11C BALL HOLDER (MAIN BODY)
11B MAIN BODY
11a FITTING PORTION
11b, 11d, 11g OIL PASSAGE HOLE
11c PROTRUSION (FIRST ABUTTING PORTION)
12 STEEL BALL (FIRST ABUTTING PORTION)
13 FILTER 14, 14A HOLDING PORTION
15 ACCOMMODATING PORTION
15a SURROUNDING PORTION
15b INWARD EXTENDING PORTION
20 SECOND CONDUCTIVE PORTION
22a END SURFACE (SECOND ABUTTING PORTION)

1. A connection device that electrically connects a conductive member and a rotary shaft that is hollow and rotatably supported by a bearing, the connection device comprising:
a first conductive portion having conductivity, including a recess, and attached to an end of the rotary shaft in such a manner that an opening of the recess faces outward; and
a second conductive portion abutting on a bottom of the recess with one end being inserted into the recess and having another end being attached to the conductive member, the second conductive portion electrically connecting the first conductive portion and the conductive member,
wherein the first conductive portion includes:
a fitting portion that is provided on an outer peripheral surface of the first conductive portion and is fitted and fixed to an inner peripheral surface of the end of the rotary shaft; and
a first abutting portion that is provided at the bottom of the recess in the first conductive portion and abuts on the second conductive portion,
an oil passage hole penetrating the bottom of the recess is formed around the first abutting portion at the bottom of the recess in the first conductive portion,
the second conductive portion includes a second abutting portion that is provided at the one end of the second conductive portion and abuts on the first abutting portion,
at least one of the first abutting portion and the second abutting portion has a protrusion shape, and
the first abutting portion and the second abutting portion abut on each other on a rotation axis of the rotary shaft.

2. The connection device according to claim 1, wherein
the first conductive portion includes:
a main body that has conductivity, includes the recess, and has an outer peripheral surface on which the fitting portion is provided; and
a steel ball that has conductivity and is attached to the bottom of the recess of the main body to constitute the first abutting portion.

3. The connection device according to claim 2, wherein
the recess of the main body has a bottom surface provided with an accommodating portion that has a recess shape and accommodates the steel ball inside, and
the accommodating portion includes:
a surrounding portion that has a tubular shape, extends along a direction of the rotation axis of the rotary shaft and surrounds the steel ball; and
an inward extending portion that extends inward from an end of the surrounding portion on a side close to a bottom of the recess shape of the accommodating portion, the inward extending portion abutting on the steel ball.

4. The connection device according to claim 2, wherein
the recess of the main body has a bottom surface provided with a hole in which the steel ball is disposed, and
the first conductive portion further includes a holding portion that has conductivity, is provided at a rim of the hole in the main body, and holds the steel ball by crimping.

5. The connection device according to claim 1, wherein the first conductive portion further includes a filter that covers the oil passage hole.

6. The connection device according to claim 1, wherein
an opening area of one end and an opening area of another end of the oil passage hole are different from each other, and
the one end and the another end of the oil passage hole are at different positions in a rotation direction of the rotary shaft.

7. A connection device that electrically connects a conductive member and a rotary shaft that is hollow and rotatably supported by a bearing, the connection device comprising:
a first conductive portion having conductivity, including a recess, and attached to an end of the rotary shaft in such a manner that an opening of the recess faces outward; and
a second conductive portion abutting on a bottom of the recess with one end being inserted into the recess and having another end being attached to the conductive member, the second conductive portion electrically connecting the first conductive portion and the conductive member,
wherein the first conductive portion includes:
a main body that has conductivity, includes the recess, and has an outer peripheral surface on which a fitting portion is formed, the fitting portion being fitted and fixed to an inner peripheral surface of the end of the rotary shaft;
a steel ball that has conductivity and is disposed in a hole provided in a bottom surface of the recess of the main body; and
a plurality of holding portions that have conductivity, are provided at a rim of the hole of the main body, and hold the steel ball by crimping,
the second conductive portion includes a second abutting portion that is provided at the one end of the second conductive portion and abuts on the steel ball,
the steel ball and the second abutting portion abut on each other on a rotation axis of the rotary shaft,
the plurality of holding portions are provided at predetermined intervals along a circumferential direction at the rim of the hole of the main body, and
an oil passage hole formed by a gap between the rim of the hole and the steel ball is provided in a portion where the holding portions are not provided in the rim of the hole of the main body.
